(19) United States
(12) Patent Application Publication
(10) Pub. No.: US 2012/0148116 A1
(43) Pub. Date: Jun. 14, 2012

(54) Identity Verification Device

(76) Inventor: Jang Jin Chae, Gyeonggi-do (KR)

(21) Appl. No.: 13/390,688

(22) PCT Filed: Jul. 28, 2010
(86) PCT No.: PCT/KR2010/004951

§ 371 Date: Feb. 15, 2012

(30) Foreign Application Priority Data
Aug. 24, 2009 (KR) 10-2009-0078260

(51) Int. Cl. G06K 9/62

(52) U.S. Cl. 382/117

(57) ABSTRACT

Provided is an apparatus for identifying person's identity. User's eyeballs may be precisely located in an operation region of the apparatus for identifying the person's identity, i.e., a photograph region in which an iris image of a user to be identified by the camera can be photographed using an indicator provided by the apparatus for identifying the person's identity. Also, a limitation in which the user's eyeballs are located at positions different from each other due to person's parallaxes different from each other even though the indicator is provided at the same position may be solved to locate the eyeballs of the user to be identified using the apparatus for identifying the person's identity at the same position.

### CROSS-REFERENCE TO RELATED APPLICATIONS

The present application is a national phase application and claims the priority benefit of PCT application number PCT/KR2010/004951 filed Jul. 28, 2010, which claims the priority benefit of K.R. patent application number 10-2009-0078260 filed Aug. 24, 2009. The disclosures of the aforementioned applications are incorporated herein by reference.

### TECHNICAL FIELD

The present disclosure relates to an apparatus for identifying person's identity.

### BACKGROUND ART

Apparatuses for identifying person's identity on the basis of human's biometric information to identify a person which is freely accessible to a specific establishment are being used in recent years. For example, there are iris recognition apparatuses in which a human's iris is photographed to compare the photographed iris information with iris information stored in database, thereby identifying person's identity.

Such an iris recognition apparatus photographs a user's iris image using a camera. Here, the iris recognition apparatus requires a high-definition clear iris image so as to compare the photographed iris information with iris information stored in database.

Thus, it may be necessary to allow the user to precisely locate the own iris in a region in which the camera of the iris recognition apparatus can photograph high-definition clear iris images.

### DISCLOSURE OF THE INVENTION

### Technical Problem

Embodiments provide an apparatus for identifying person's identity which include an indication part for precisely guiding user's eyeballs into an operation region of the apparatus for identifying person's identify.

### Technical Solution

In one embodiment, an apparatus which collects body information of a user to identify user's identity includes: an indication part providing an indicator to only one eye of user's two eyes; a mirror part by which a body of the user aligned with respect to the indicator is mirrored; a collection part collecting the body information from the aligned body of the user; and a control part controlling an operation of the apparatus for identifying the user's identity.

### Advantageous Effects

According to the embodiments, the user's eyeballs may be precisely located in the operation region of the identification apparatus, i.e., the photograph region in which the iris image of the user to be identified by the camera can be photographed using the indicator provided by the identification apparatus.

Also, the limitation in which the user's eyeballs are located at positions different from each other due to the person's parallaxes different from each other even though the indicator is provided at the same position may be solved to locate the eyeballs of the user to be identified using the identification apparatus at the same position.

### BRIEF DESCRIPTION OF THE DRAWINGS

FIG. 1 is a schematic view of an apparatus for identifying person's identity according to an embodiment.

FIG. 2 is an enlarged view illustrating a portion A of FIG. 1 so as to explain a structure of an indication part according to an embodiment.

FIGS. 3 to 5 are views for explaining limitations occurring when eyeballs of a user having parallaxes different from each other are aligned using indicators in a case where the indicators are respectively provided to two eyes of the user.

FIG. 6 is a plan view of an indication part according to another embodiment.

FIG. 7 is a plan view of an indication part according to another embodiment.

FIG. 8 is a schematic view of an apparatus for identifying person's identity according to another embodiment.

FIG. 9 is an enlarged view illustrating a portion A of FIG. 8 so as to explain a structure of an indication part according to another embodiment.

FIG. 10 is a plan view of an indication part according to another embodiment.

FIG. 11 is a plan view of an indication part according to another embodiment.

FIGS. 12 to 14 are front views for explaining an operation of an indication part according to an embodiment.

### MODE FOR CARRYING OUT THE INVENTION

Hereinafter, specific embodiments will be described in detail with reference to the accompanying drawings.

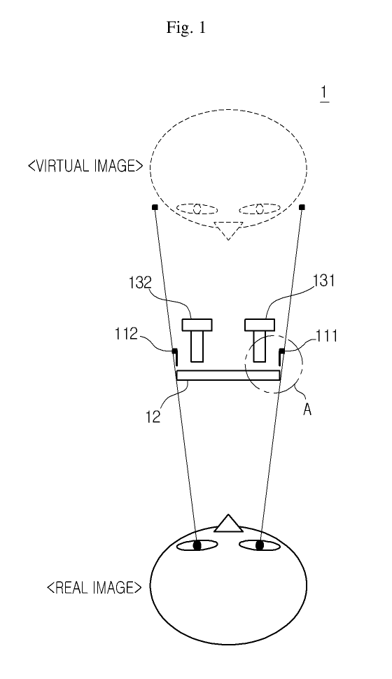

FIG. 1 is a schematic view of an apparatus 1 for identifying person's identity according to an embodiment.

Referring to FIG. 1, the apparatus 1 for identifying person's identity (hereinafter, referred to as an “identification apparatus”) includes indication parts 111 and 112 for providing an indicator to only one eye of two eyes of a user, a mirror part 12 through which the body of the user aligned with respect to the indicator is mirrored, collection parts 131 and 132 for collecting body information from the aligned body of the user, and a control part (not shown) for controlling an operation of the identification apparatus 1.

The identification apparatus 1 may be an apparatus which collects the body information of the user to identify user's identity. For example, the identification apparatus 1 may include an iris recognition apparatus for photographing a user's iris image to identify user's identity or a face recognition apparatus for recognizing a user's face to identify user's identity.

Hereinafter, in detailed descriptions of the embodiments, although it may be assumed that the identification apparatus 1 is the iris recognition apparatus, the present disclosure is not limited thereto. For example, contents with respect to the recognition apparatus 1 according to the embodiments may be applied to various types of apparatuses which collect information with respect to any portion of the user's body to identify user's identity.

The indication parts 111 and 112 provide the indicator to the user to be identified through the identification apparatus 1. The indicator may be an indication for guiding two eyes of a user into an operation region of the identification apparatus 1, i.e., a region in which body information of the user required for identifying user's identity can be collected.

For example, the user may adjust positions of own eyeballs to allow the indicator to be located at a center of own two eyes mirrored through the mirror part 12 while confirming the indicator provided from the indication parts 111 and 112 through the own two eyes. Thus, the user may locate the own two eyes in the operation region of the identification apparatus 1.

According to the current embodiment, the indication parts 111 and 112 may provide the indicator to only one eye of the user's two eyes. That is, the indication parts 111 and 112 do not provide the indicator to all of the user's two eyes, but provide only one eye of the user's two eyes. Thus, the user may confirm the indicator provided from the indication parts 111 and 112 through only one of left and right eyes.

The mirror part 12 may mirror the user's body aligned with respect to the indictor. For example, when the identification apparatus 1 is the iris recognition apparatus, the user may mirror own eyeballs on the mirror part 12 to adjust positions of the own eyeballs using the indicator provided by the indication parts 111 and 112 so that the own eyeballs are located in the operation region of the iris recognition apparatus.

The collection parts 131 and 132 collect body information from the aligned user's body.

According to the current embodiment, each of the collection parts 131 and 132 may be a camera which can photograph a user's iris image. The collection parts 131 and 132 may collect user's body information from the aligned user's body using the indicator. The identification apparatus 1 may confirm the user's identity by comparing the collected user's body information with body information stored in database.

According to the current embodiment, each of the indication parts 111 and 112 may include a light source having a predetermined width and spaced a predetermined distance from the mirror part 12 and a light path restriction part extending from the light source toward the mirror part 12 to restrict a path of light emitted from the light source.

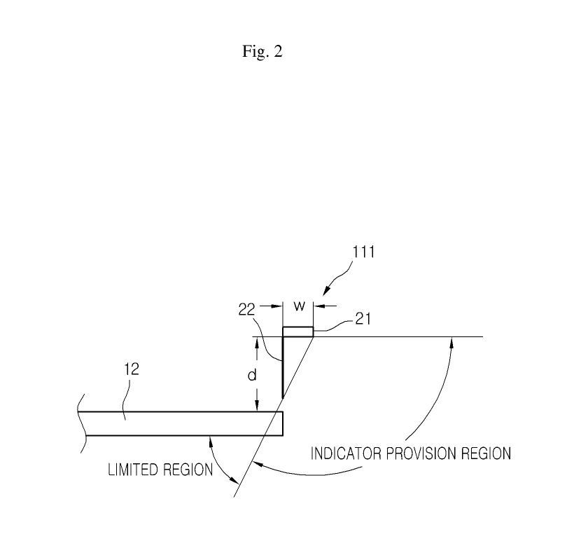

FIG. 2 is an enlarged view illustrating a portion A of FIG. 1 so as to explain a structure of an indication part according to an embodiment.

Referring to FIG. 2, the indication part 111 according to the current embodiment may include a light source 21 having a predetermined width w and spaced a predetermined distance d from the mirror part 12 and a light path restriction part 22 extending from the light source 21 toward the mirror part 12 to restrict a path of light emitted from the light source 21.

The light source 21 may be a unit for emitting light, for example, a light emitting device such as an LED or a lamp.

The light source 21 has the predetermined width w and is spaced the predetermined distance d from the mirror part 12 within the identification apparatus 1.

The light path restriction part 22 is attached to the light source 21 to restrict the path of light emitted from the light source 21. That is, the light path restriction part 22 has a side attached to the light source 21 and extends by a predetermined length toward the mirror part 12.

In FIG. 2, the light path restriction part 22 is attached to a left side of the light source 21 to restrict the light emitted from the light source 21 so that the light does not travel toward the left side of the light source 21 beyond a predetermined range in which the indicator is provided.

As a result, the indication part 111 for a right eye of the user may serve as an indicator for guiding the user's eye ball to allow the user's eye ball to be located in the operation region of the identification apparatus 1. Thus, the indication part 111 may provide light emitted from the light source 21 to the right eye, but do not provide the emitted light to the other eye, i.e., a left eye of the user.

Thus, the indication part 111 of the identification apparatus 1 may provide the indicator to only one eye of the user's two eyes. Similarly, the other indication part 112 of the identification apparatus 1 may provide the indicator to only a left eye of the user's two eyes, thereby preventing the light from traveling into the right eye.

According to the current embodiment, since the indication parts 111 and 112 provides the indicator to only one eye without providing the indictor to the user's two eyes, a limitation in which the user's eyeballs aligned using the indicator are disposed at positions different from each other due to user's different parallaxes may be solved.

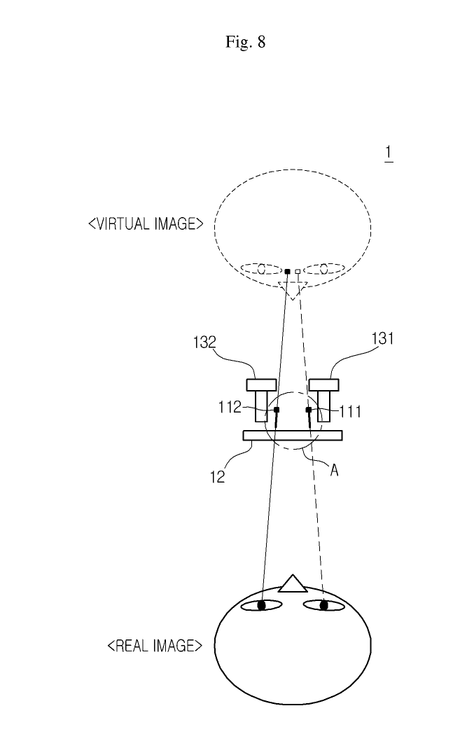

Although the indication parts 111 and 112 are disposed in an outer region of the mirror part 12, i.e., outside the user's eyeballs in FIG. 1, the present disclosure is not limited to the positions of the indication parts 111 and 112. For example, as shown in FIG. 8, the indicator parts 111 and 112 may be disposed in an inner region of the mirror part 12, i.e., inside the user's eyeballs.

In this case, as shown in FIG. 8, the user may adjust positions of the own eyeballs using the indicator provided to only one of the indication parts 111 and 112 so that the indicator is located at a center of the user's eyeballs mirrored by the mirror part 12, thereby locating the user's eyeballs within the operation region of the identification apparatus 1.

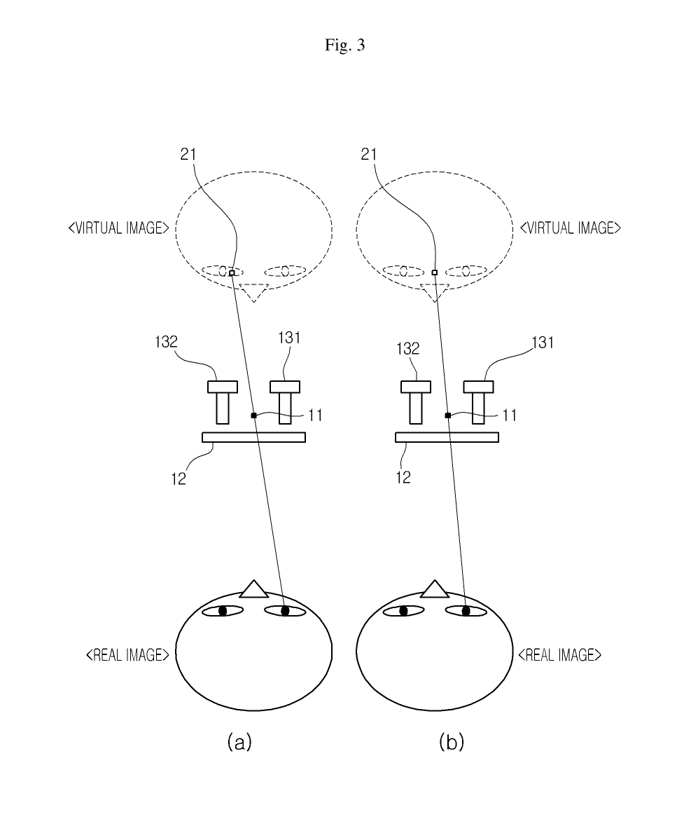

FIGS. 3 to 5 are views for explaining limitations occurring when eyeballs of a user having parallaxes different from each other are aligned using indicators in a case where the indicators are respectively provided to two eyes of the user.

An identification apparatus 1 used in FIGS. 3 to 5 may include one indication part 11 at a center of two cameras 131 and 132 for collecting iris images of a user and provide indicators to both two eyes of the user to allow both two eyes of the user, left and right eyes to confirm the indicators.

In this case, when an image viewed by the user's right eye is strongly recognized than an image viewed by the user's left eye, i.e., when the user's right eye is strong and the user's left eye is week, as shown in FIG. 3A, the user may recognize as if a position 21 of the indication part 11 mirrored by the mirror part 12 is adjacent to the user's left eye even though an actual position 11 of the indication part is disposed at the center between the user's two eyes.

Thus, as shown in FIG. 3B, the user may move the own face in a left direction to locate the indicator at the center of the own two eyes mirrored by the mirror part 12. Thus, the position 21 of the indication part 21 confirmed through the mirror part 12 is located at the center of the own two eyes.

As a result, even though the user adjusts the positions of the own eyeballs so that the indicator is located at the center of the own two eyes mirrored by the mirror part 12, the user's eyeballs may be located at a region out of the operation region of the identification apparatus 1. Thus, the collection parts 131 and 132 may not collect iris images of the user.

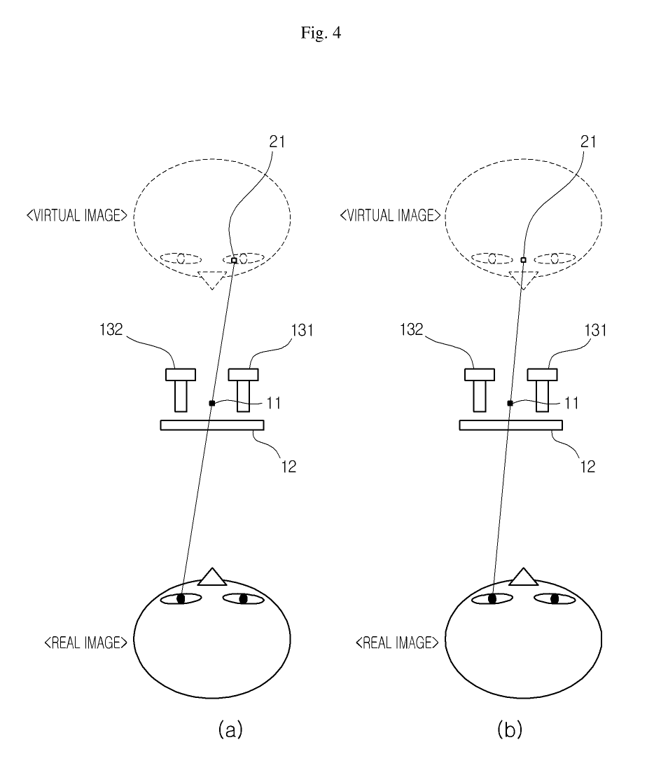

On the other hand, when an image viewed by the user's left eye is strongly recognized than an image viewed by the user's right eye, i.e., when the user's left eye is strong and the user's left eye is week, as shown in FIG. 4A, the user may recognizes as if a position 21 of the indication part 11 mirrored by the mirror part 12 is adjacent to the user's right eye even though an actual position 11 of the indication part is disposed at the center between the user's two eyes.

Thus, as shown in FIG. 4B, the user may move the own face in a right direction to locate the indicator at the center of the own two eyes mirrored by the mirror part 12. Thus, the position 21 of the indication part 21 confirmed through the mirror part 12 is located at the center of the own two eyes.

Similarly, the user's eyeballs may be located at a region out of the operation region of the identification apparatus 1. Thus, the collection parts 131 and 132 may not collect iris images of the user.

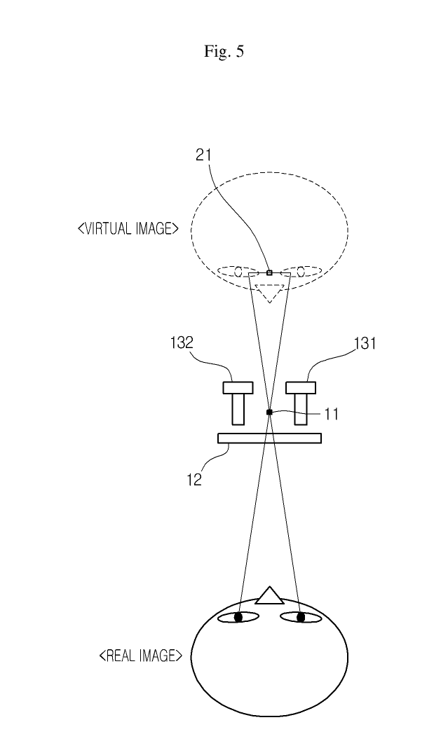

If the image viewed by the user's right eye and the image viewed by the user's left eye are recognized as the same, as shown in FIG. 5, the user may recognize as if the position 21 of the indicator is located at the center of the user's two eyes.

As described above, everyone may have parallaxes different from each other. Thus, when the indication part 11 provides the indicator to the user's two eyes, the identification apparatus 1 may not recognize the user's eyeballs even though the user locates the indicator at the center of the own two eyes mirrored by the mirror part 12.

However, according to the current embodiment, the indicator may be provided to only one eye without being provided to both eyes of the user to locate the own eyeballs at the same positions with respect to the identification apparatus 1 regardless of person's parallaxes different from each other.

According to an embodiment, the indication parts 111 and 112 may include a first indication part 111 for one eye of the user, i.e., a right eye and a second indication part 112 for the other eye of the user, i.e., a left eye. That is, the indication parts 111 and 112 may include two indication parts for left and right eyes of the user.

In this case, the control part may control one of the first and second indication parts 111 and 112 at a time to operate the one indication part. That is, even though the identification apparatus 1 includes the two indication parts 111 and 112, only one indication part may be operated at a time to allow the user to confirm the indicator through only one eye of the own two eyes.

However, the present disclosure is not limited thereto. For example, the first and second indication parts 111 and 112 may be operated at the same time to allow the first indication part 111 to provide an indicator to only the user's right eye and allow the second indication part 112 to provide an indicator to only the user's left eye.

Specifically, as shown in FIG. 1, when the indicator is located outside the user's eyeballs, the first and second indication parts 111 and 112 may be operated at the same time so as to accurately be operated.

In this case, since the user may confirm the indicator provided by the only one indication part as ever, the limitation in which the position of the indicator is differently grasped for each user may be solved.

According to another embodiment, the identification apparatus 1 may include only one indication part without including the two indication parts 111 and 112. That is, the identification apparatus 1 may include only one indication part to always provide the indicator to only one eye of the user's two eyes.

According to an embodiment, the light path restriction part 22 may be inclined at a predetermined angle with respect to a plane of the mirror part 12.

For example, as shown in FIG. 2, the light path restriction part 22 may be inclined at an angle of about 90° with respect to the plane of the mirror part 12.

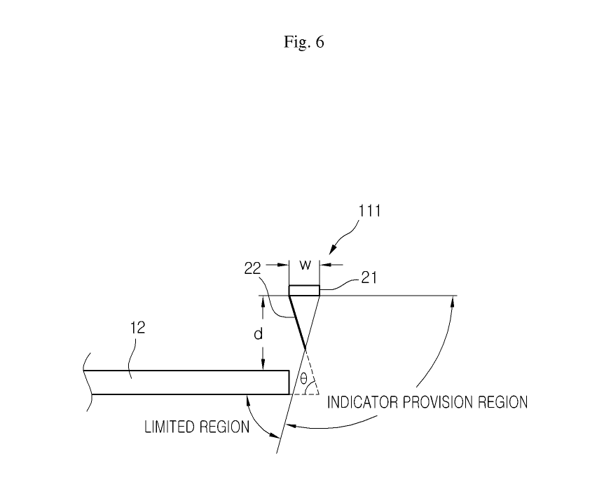

For example, as shown in FIG. 6, the light path restriction part 22 may be disposed inclined at a predetermined angle θ with respect to the plane of the mirror part 12.

As described above, the light path restriction part 22 may be inclined at a predetermined angle with respect to the plane of the mirror part 12 to set a traveling range of light emitted from the light source 21, i.e., an indictor provision region.

For example, the more the angle θ defined by the light path restriction part 22 and the plane of the mirror part 12 is decreased, the more the traveling range of the light emitted from the light source 21, i.e., the indicator provision region may be decreased. On the other hand, the more the angle θ defined by the light path restriction part 22 and the plane of the mirror part 12 is increased, the more the traveling range of the light emitted from the light source 21 may be increased.

Also, the range in which the indicator is provided may be determined by a width w of the light source 21 and a distance d from the mirror part 12 from the light source 21 except for the angle θ defined by the light path restriction part 22 and the mirror part 12.

According to an embodiment, the more the distance d from the light source 21 to the mirror part 12 is decreased, the more the width w of the light source 21 may be decreased.

That is, to prevent light emitted from the light source 21 from traveling into the other eye of the user, the more the distance d from the light source 21 to the mirror part 12 is decreased, the more the width w of the light source 21 may be decreased.

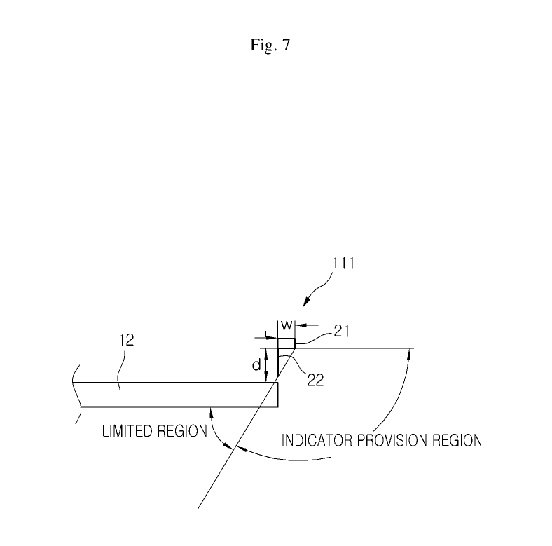

For example, as shown in FIG. 7, the indictor part 111 of FIG. 7 may have a distance d between the light source 21 and the mirror part 12 less than that d of FIG. 2. Thus, the width w of the light source 21 may be decreased to prevent the traveling range of the light emitted from the light source 21, i.e., the indicator provision range from being expanded up to the other eye of the user.

Similarly, the more the distance d between the light source 21 and the mirror part 12 is decreased, the more the angle θ defined by the light path restriction part 22 and the plane of the mirror part 12 may be decreased. As a result, even though the distance d between the light source 21 and the mirror part 12 is decreased to reduce a size of the identification apparatus 1, the width w of the light source 21 or the angle θ defined by the light path restriction part 22 and the mirror part 12 may be adjusted to prevent the light emitted from the light source 21 from traveling into the other eye of the user, thereby adjusting the indicator provision region.

According to an embodiment, each of the indication parts 111 and 112 for providing the indicator to only one eye of the user may be disposed at a predetermined position with respect to the mirror part 12.

For example, as shown in FIG. 1, the indication part 111 and 112 may be disposed outside the mirror part 12 to display the indicator on the outside of the user's eyes.

Also, as shown in FIG. 8, the indication parts 111 and 112 may be disposed inside the mirror part 12 to display the indicator between the user's two eyes.

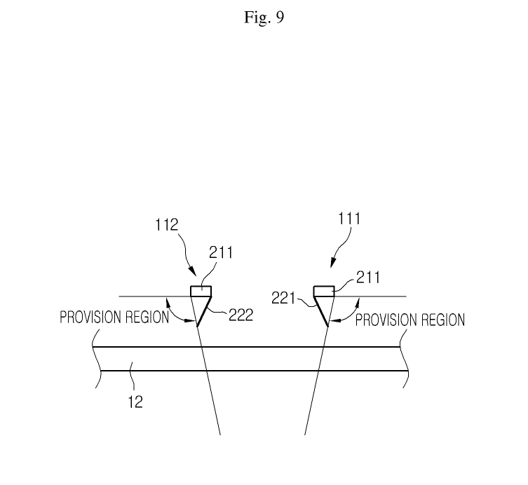

FIG. 9 is an enlarged view illustrating a portion A of FIG. 8 so as to explain a structure of an indication part according to another embodiment.

Referring to FIG. 9, the indication parts 111 and 112 may be disposed inside the mirror part 12, i.e., between the collection parts 131 and 132.

Similar to the indication parts 111 and 112 of FIG. 1, the indication parts 111 and 112 may include light sources each having a predetermined width and spaced a predetermined distance from the mirror part 12 and light path restriction parts 221 and 222 extending from the light sources 211 and 212 toward the mirror part 12 to restrict paths of light emitted from the light source.

Similarly, each of the light path restriction parts 221 and 222 may be inclined at a predetermined angle with respect to a plan of the mirror part 12 to restrict the light paths of the light emitted from the light sources 211 and 212 so that the light travels into only one eye of the user. That is, the light emitted from the light source 211 may travels into only a right eye of the user, and the light emitted from the light source 212 may travel into only a left eye of the user.

Similarly, the more a distance from the light sources 211 and 212 to the mirror part 12 is decreased, the more a width of each of the light sources 211 and 212 may be decreased. Thus, light emitted from one light source may travel into only one eye of the user.

According to an embodiment, each of the light path restriction parts 221 and 222 may be formed of an opaque light-absorbing material to prevent the light emitted from the light source from being reflected.

According to an embodiment, as shown in FIGS. 1 and 8, the light path restriction part 22 may be attached to a side of the light source to serve as a blocking wall extending toward the mirror part 12.

According to another embodiment, the light path restriction part 22 may have one end on which the light source is disposed and have a tube shape extending toward the mirror part 12.

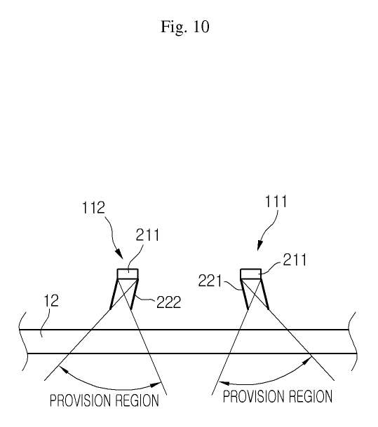

For example, as shown in FIG. 10, each of the light path restriction parts 221 and 222 may have one end on which the light sources 211 and 212 are disposed and the other end having a tube shape extending toward the mirror part 12. In this case, each of the light path restriction parts 221 and 222 may have a circular, square, or polygonal shape.

Similarly, each of the tube-shaped light path restriction parts 221 and 222 may be inclined at a predetermined angle with respect to a plan of the mirror part 12.

According to another embodiment, the light source may include a plurality of sub light sources.

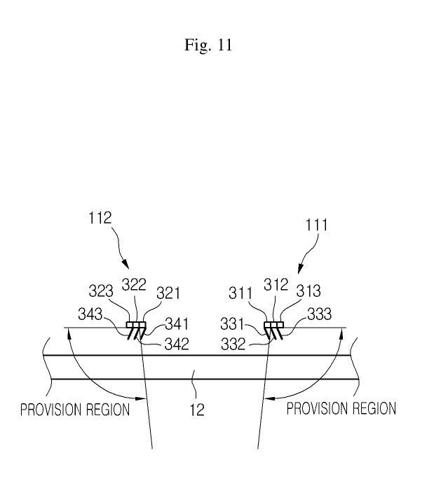

FIG. 11 is a plan view of an indication part according to another embodiment.

Referring to FIG. 11, the indication part 111 may include a plurality of sub light sources 311, 312, and 313 and a plurality of sub light path restriction parts 331, 332, and 333.

When a distance from the light source to the mirror part 12 is decreased to reduce a size of the identification apparatus 1, a width of the light source may be decreased also to prevent the light emitted from the light source from traveling into the other eye of the user. However, in this case, when the width of the light source is decreased, an amount of light emitted from the light source may be reduced also. Thus, the user does not confirm the indicator.

In another embodiment of FIG. 11, since the distance between the light source and the mirror part 12 is decreased to decrease the width of the light source, a plurality of light sources may be disposed in a width direction thereof to prevent a phenomenon in which the user does not recognize the indicator from occurring.

Thus, even though the width of the light source is decreased to reduce the amount of light emitted from the single light source, the indication part according to another embodiment may provide the light emitted from the plurality of light sources to the user's one eye. Therefore, the user may confirm the indicator provided from the indication part.

Also, since the number of light sources is increased, light path restriction parts 331, 332, and 333 are provided in plurality to restrict a path of light emitted from each of the light sources.

Thus, each of the indication parts 111 and 112 may provide the indicator to only one eye of the user's two eyes.

According to an embodiment, the identification apparatus 1 may further include a distance measurement part (not shown) for measuring a distance between the identification apparatus 1 and the user.

The distance measurement part may be a sensor. The distance measurement part may be mounted on the identification apparatus 1 to measure the distance between the identification apparatus 1 and the user.

According to an embodiment, the indication part may include a plurality of sub light sources in a vertical direction of the identification apparatus 1.

That is to say, in addition to the indication part including the plurality of sub light sources in a horizontal direction as shown in FIG. 11, the indication part according to an embodiment may include the plurality of sub light sources in the vertical direction of the identification apparatus 1.

In this case, the control part may operate the sub light sources by combing the sub light sources with each other according to distances between the identification apparatus 1 and the user.

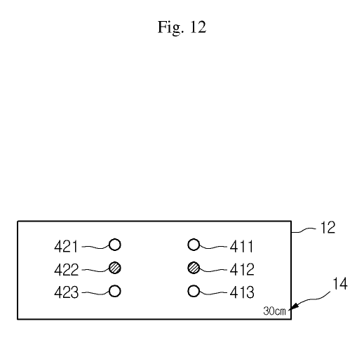

FIGS. 12 to 14 are front views for explaining an operation of an indication part according to an embodiment.

Referring to FIGS. 12 to 14, an indication part of the identification apparatus 1 includes three sub light sources. However, the present disclosure is not limited thereto. For example, two or more sub light sources may be provided.

The identification apparatus 1 may operation the sub light sources by combining the sub lights with each other according to distances between the identification apparatus 1 and the user.

For example, when the distance between the identification apparatus 1 and the user, which is measured by the distance measurement part, is less than an operation distance of the identification apparatus 1, as shown in FIG. 12, only a middle sub light source 412 of three sub light sources 411, 412, and 413 may emit light.

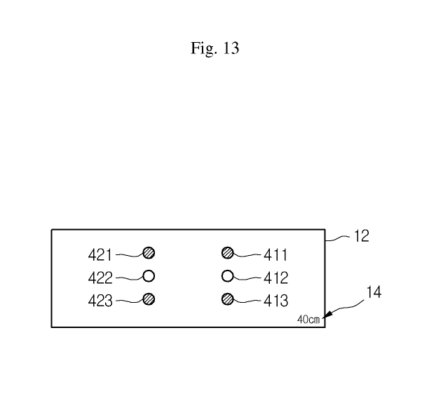

On the other hand, when the distance between the identification apparatus 1 and the user, which is measured by the distance measurement part, is greater than the operation distance of the identification apparatus 1, as shown in FIG. 13, only outer sub light sources 411 and 413 of the three sub light sources 411, 412, and 411 may emit light.

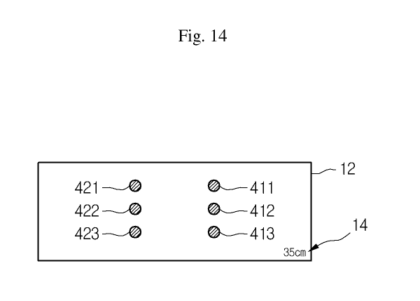

Also, when the distance between the identification apparatus 1 and the user, which is measured by the distance measurement part, exists within the operation region of the identification apparatus 1, as shown in FIG. 14, the three sub light sources 411, 412, and 411 may emit light at the same time.

As described above, the indication part may include the plurality of sub light sources to operate the sub light sources by combining the sub light sources with each other according to the distances between the identification part 1 and the user. The combination of the sub light sources is not limited to those described in FIGS. 12 to 14. For example, the sub light sources may be variously combined with each other.

According to another embodiment, the control part may operate the sub light sources by combing the sub light sources with each other according to an identification process of the identification apparatus 1.

For example, when the collection parts 131 and 132 of the identification apparatus 1 collect body information of the user, as shown in FIG. 12, only the middle sub light source 412 of the plurality of sub light sources 411, 412, and 413 may be operated.

Also, when the identification apparatus 1 successively collects the body information of the user and then compares the collected body information with body information stored in database, as shown in FIG. 13, only the outer sub light sources 411 and 413 of the plurality of sub light sources 411, 412, and 413 may be operated.

When the identification apparatus confirms the identity of the user to determine that the collected body information is matched or mismatched with the body information stored in the database, the plurality of sub light sources 411, 412, and 413 may be operated at the same time.

According to another embodiment, the control part may control the light source to allow the light source to emit light according to the distance between the identification apparatus 1 and the user or the progress of the identification process.

For example, when the light source is a three color LED emitting light having a plurality of colors, the control part may control the light source to allow the light source to emit light different from each other according to the distance between the identification apparatus 1 and the user or the progress of the identification process.

According to another embodiment, as shown in FIGS. 12 to 14, a display device for displaying distance information between the identification apparatus 1 and the user may be disposed on a portion (e.g., a right lower end) of the mirror part 12 to provide the distance information to the user.

According to the embodiments, the identification apparatus 1 may include at least one indication to provide the indicator to only one eye of the user's two eyes. Thus, the eyeballs of the user may be guided into the operation region of the identification apparatus 1 regardless of person's parallaxes different from each other.

The present disclosure has been described above with reference to the aforementioned embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. An apparatus which collects body information of a user to identify user's identity, the apparatus comprising:
an indication part providing an indicator to only one eye of user's two eyes;
a mirror part by which a body of the user aligned with respect to the indicator is mirrored;
a collection part collecting the body information from the aligned body of the user; and
a control part controlling an operation of the apparatus for identifying the user's identity.

2. The apparatus according to claim 1, wherein the indication part comprises:
a light source having a predetermined width and spaced a predetermined distance from the mirror part; and
a light path restriction part extending from the light source toward the mirror part to restrict a path of light emitted from the light source.

3. The apparatus according to claim 2, wherein the light path restriction part is inclined at a predetermined angle with respect to a plane of the mirror part.

4. The apparatus according to claim 2, wherein the light path restriction part is formed of an opaque light-absorbing material.

5. The apparatus according to claim 2, wherein the more a distance from the light source to the mirror part is decreased, the more a width of the light source is decreased.

6. The apparatus according to claim 3, wherein the more a distance from the light source to the mirror part is decreased, the more an inclined angle is decreased.

7. The apparatus according to claim 1, wherein the indication part comprises a first indication part for one eye of the user and a second indication part for the other eye of the user, and the control part operates only one of the first and second indication parts.

8. The apparatus according to claim 1, further comprising a distance measurement part for measuring a distance between the apparatus for identifying the user's identity and the user.

9. The apparatus according to claim 2, wherein the light source comprises a plurality of sub light sources, and
the control part operates the sub light sources by combining the sub light sources with each other according to a distance between the apparatus for identifying the user's identity and the user or an identification process.

10. The apparatus according to claim 2, wherein the control part controls the light source to allow the light source to emit light having colors different from each other according to a distance between the apparatus for identifying the user's identity and the user or an identification process.
